(19) United States
(12) Patent Application Publication
(10) Pub. No.: US 2012/0147044 A1
(43) Pub. Date: Jun. 14, 2012

(54) IMAGE PROCESSING APPARATUS, IMAGE PROCESSING METHOD AND IMAGE PROCESSING PROGRAM

(75) Inventor: Tomoyuki SAITO, Kanagawa (JP)

(73) Assignee: Renesas Electronics Corporation, Kanagawa (JP)

(21) Appl. No.: 13/304,121

(22) Filed: Nov. 23, 2011

(30) Foreign Application Priority Data
Dec. 8, 2010 (JP) 2010-273563

(51) Int. Cl. G09G 5/00

(52) U.S. Cl. 345/634

(57) ABSTRACT

An image processing apparatus for generating a paging image when a display image for a plurality of pages is displayed for each page, includes a display control unit that calculates an area to be displayed used for generation of the paging image, a back image processing unit that adjusts a scale of the area to be displayed for the back page image on the basis of a position of the display boundary to generate a display back page image, and a mixer unit that generates a combined image in which the present image and the next image are combined together on the basis of the display boundary, and superimposes the display back page image on the combined image on the basis of the display boundary to generate the paging image.

### CROSS-REFERENCE TO RELATED APPLICATIONS

The disclosure of Japanese Patent Application No. 2010-273563 filed on Dec. 8, 2010 including the specification, drawings and abstract is incorporated herein by reference in its entirety.

### BACKGROUND

The present invention relates to an image processing apparatus, an image processing method, and an image processing program.

Up to now, when content treated with the use of paper is displayed on a display device such as an electronic book or a digital photo frame, a graphic effect to turn pages may be added. The feeling of treating the paper can be offered to a user by the graphic effect of turning the pages. The graphic effect of turning the pages leads to not only an improve in the operability when switching display from present content to next content, but also the effect that plural contents can be sequentially browsed. The graphic effect of turning the pages can be applied to displaying of not only a still picture but also a moving picture. For that reason, it is conceivable that the graphic effect of turning the pages is applied to not only the display device for an electronic book or a digital photo frame, but also a TV receiver. In the future, there is a possibility that a demand for the paging effect is further increased.

Japanese Unexamined Patent Publication No. Hei07(1995)-261725 discloses a technology related to a display device for realizing the paging effect. FIG. 14 is a conceptual diagram illustrating a process of generating a paging image in the display device disclosed in Japanese Unexamined Patent Publication No. Hei07(1995)-261725. Referring to FIG. 14, a description will be given of the operation of the display device disclosed in Japanese Unexamined Patent Publication No. Hei07(1995)-261725.

Original images M1, M2, and M3 of a front page, a back page, and a next page are stored in first, second, and third storage units, respectively (Step 1). A formation unit replaces an outline of the back page with a triangle, and obtains vertex coordinates of a triangle M4 (Step 2). Then, in order to generate the contents of the front page, the back page, and the next page, a work area setting unit sets first, second, and third work areas.

Thereafter, a back page generation unit generates an image M5 of the back page in the second work area on the basis of the triangle M4 indicative of the outline of the back page, which is calculated in Step 2, and the original image M2 of the back page, which is read from the second storage unit (Step 3).

Subsequently, a transfer unit transfers the original image M1 of the front page from the first storage unit into the first work area. Simultaneously, the transfer unit transfers the original image M3 of the front page from the third storage unit into the third work area. An erasure unit erases an unnecessary portion M6 from the first work area on the basis of the triangle M4 indicative of the outline of the back page. Likewise, the erasure unit erases an unnecessary portion M7 from the third work area on the basis of the triangle M4 indicative of the outline of the back page. Likewise, the erasure unit erases an unnecessary portion M7 from the third work area on the basis of the triangle M4 indicative of the outline of the back page (Step 4). Then, a combination unit combines the images on the first to third work areas together to generate a paging image (Step 5).

The display device disclosed in Japanese Unexamined Patent Publication No. Hei07(1995)-261725 conducts processing of Steps 1 to 5 every time a paging position is changed, that is, every time the shape of the back page is changed.

### SUMMARY

However, the display device disclosed in Japanese Unexamined Patent Publication No. Hei07(1995)-261725 has posed such a problem that a processing load for generating the paging image is high. The problem will be described below.

In creating the paging image (an image in Step 5 of FIG. 14), the display device of Japanese Unexamined Patent Publication No. Hei07(1995)-261725 generates processed images in the first work area and the third work area in addition to a coordinate calculating process. The display device combines the processed images stored in the first and third work areas with the image of the back page stored in the second work area. Thus, there is a need to generate the two processed images in order to generate the paging image. For that reason, in the display device, a load of the image processing becomes high.

According to one aspect of the present invention, there is provided an image processing apparatus for generating a paging image when a display image for a plurality of pages is displayed for each page, which calculates coordinates of a display boundary between a present image that is a present display image and a next image to be displayed after paging, and provides a back page image used to represent a page back associated with the display boundary, the image processing apparatus including: a display control unit that calculates an area to be displayed used for generation of the paging image; a back image processing unit that adjusts a scale of the area to be displayed for the back page image on the basis of a position of the display boundary to generate a display back page image; and a mixer unit that generates a combined image in which the present image and the next image are combined together on the basis of the display boundary, and superimposes the display back page image on the combined image on the basis of the display boundary to generate the paging image.

According to another aspect of the present invention, there is provided an image processing method for generating a paging image when a display image for a plurality of pages is displayed for each page, which calculates coordinates of a display boundary between a present image that is a present display image and a next image to be displayed after paging, and provides a back page image used to represent a page back associated with the display boundary, the image processing method including the steps of: calculating an area to be displayed used for generation of the paging image; generating a display back page image that is an image having the area to be displayed for the back page image adjusted in scale on the basis of the display boundary; and superimposing the display back page image on a combined image in which the present image and the next image are combined together on the basis of the display boundary, on the basis of the display boundary, to generate the paging image.

According to still another aspect of the present invention, there is provided a computer readable recording medium storing an image processing program that causes a computer to execute a process for calculating coordinates of a page switching image when a display image for a plurality of pages is displayed for each page, the process including: calculating a display boundary between a present image that is a present display image and a next image to be displayed after paging; and calculating an area to be displayed which is displayed during the paging image from a back page image representative of a page back associated with the display boundary on the basis of the display boundary.

According to the aspects of the present invention, the image processing apparatus adjusts the scale of the back page according to the set display boundary. After generating the combined image in which the present image and the next image are combined together on the basis of the display boundary, the image processing apparatus superimposes the display back page image in which a part or all of the back page image is adjusted in scale on the combined image to generate the paging image. In generation of the combined image, because only the present image and the next image are displayed with the display boundary, there occurs no image processing. Further, the processing on the back page image is only the adjustment of scale and the superimposing on the combined image. Thus, the image processing apparatus conducts simple processing of only the scale adjustment and the superimposing of the image without conducting processing high in processing load such as image processing, thereby generating the paging image. That is, the image processing apparatus can realize the generation of the paging image reduced in the image processing load.

According to the aspects of the present invention, there can be provided the image processing apparatus, the image processing method, and the image processing program, which realize the generation of the paging image reduced in the image processing load.

### BRIEF DESCRIPTION OF THE DRAWINGS

FIG. 1 is a block diagram illustrating a configuration of an image processing apparatus according to a first embodiment;

FIGS. 2A and 2B are conceptual diagrams illustrating display boundary screen information according to the first embodiment;

FIG. 3 is a diagram illustrating an example of a back page image according to the first embodiment;

FIG. 4 is a conceptual diagram illustrating one process of generating a paging image in the image processing apparatus according to the first embodiment;

FIG. 5 is a conceptual diagram illustrating another process of generating a paging image in the image processing apparatus according to the first embodiment;

FIG. 6 is a conceptual diagram illustrating one calculation of paging coordinates in the image processing apparatus according to the first embodiment;

FIGS. 7A to 7C are conceptual diagrams illustrating another calculation of paging coordinates in the image processing apparatus according to the first embodiment;

FIGS. 8A to 8C are conceptual diagrams illustrating still another calculation of paging coordinates in the image processing apparatus according to the first embodiment;

FIGS. 9A to 9C are conceptual diagrams illustrating yet still another calculation of paging coordinates in the image processing apparatus according to the first embodiment;

FIGS. 10A to 10C are conceptual diagrams illustrating yet still another calculation of paging coordinates in the image processing apparatus according to the first embodiment;

FIG. 11 is a conceptual diagram illustrating designation of a paging position in the image processing apparatus according to the first embodiment;

FIG. 12 is a flowchart illustrating processing of the image processing apparatus according to the first embodiment;

FIG. 13 is a diagram illustrating a configuration of a computer for executing the image processing according to the first embodiment; and

FIG. 14 is a block diagram illustrating a configuration of a display device in Japanese Unexamined Patent Publication No. Hei07(1995)-261725.

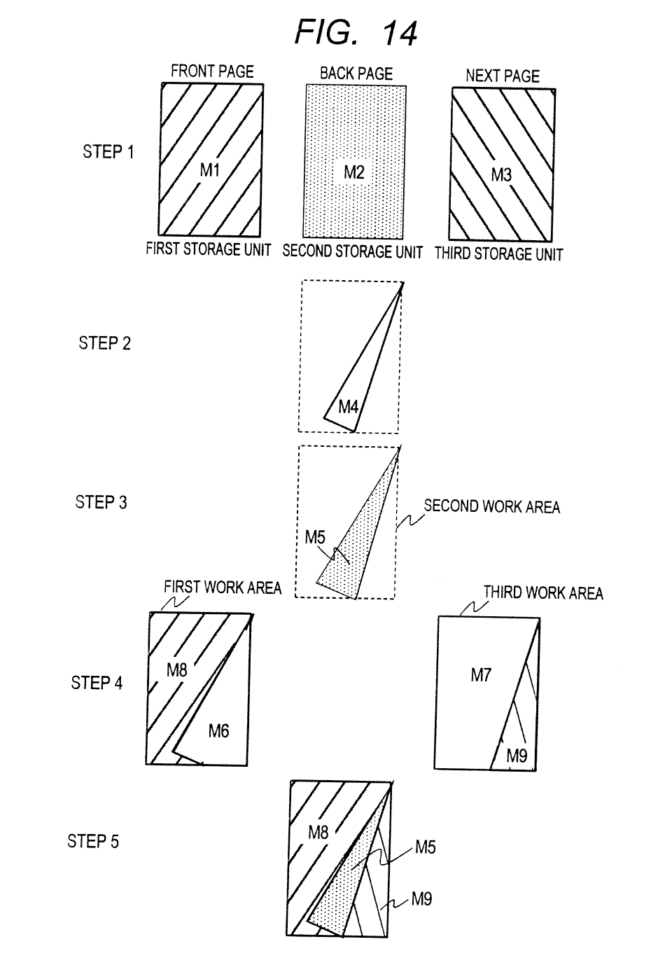

### DETAILED DESCRIPTION

### First Embodiment

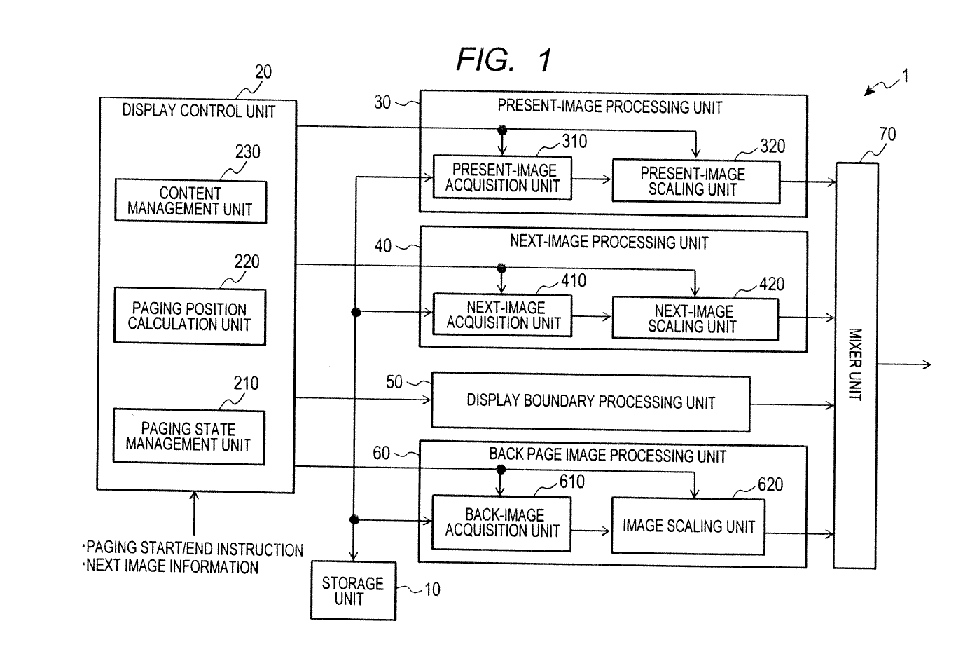

Hereinafter, an embodiment of the present invention will be described with reference to the accompanying drawings. FIG. 1 is a block diagram illustrating a configuration of an image processing apparatus according to this embodiment. An image processing apparatus 1 includes a storage unit 10, a display control unit 20, a present-image processing unit 30, a next-image processing unit 40, a display boundary processing unit 50, a back page image processing unit 60, and a mixer unit 70. The image processing apparatus 1 is, for example, an image processing apparatus having a liquid crystal display, more particularly a TV receiver. In the following description, it is assumed that the image processing apparatus 1 is a TV receiver having a liquid crystal display that is 800 in the number of horizontal pixels and 480 in the number of vertical pixels.

The storage unit 10 stores a still image or a moving image therein. The storage unit 10 is preferably a RAM (random access memory), but is not always limited to the RAM, and may be any storage device that can read an image from the present-image processing unit 30 to be described later at a high speed. Also, if an image can be read from the present-image processing unit 30 to be described later at a high speed, the storage unit 10 may be arranged outside the image processing apparatus 1.

The display control unit 20 includes a paging state management unit 210, a paging position calculation unit 220, and a content management unit 230. The display control unit 20 receives a paging start/end instruction and designation of an image to be displayed after paging from a user. In the following description, it is assumed that an image to be displayed before paging is a present image, an image to be displayed after paging is a next image, and an image for representing a back side of the page is a back page image. Also, the present image, the next image, and the back page image are superimposed on each other, and an image for displaying the paging effect is referred to as “paging image”.

The user conducts the start instruction of paging and the designation of the next image, for example, with the use of a remote controller for the TV receiver. As the next image, an arbitrary image can be selected from a displayable content. For example, previous and next pages (page 34, page 36) can be designated while displaying page 35 in the content of 100 pages, and previous and next pages of page 10, or a first page (page 1) can be designated. As a result, redisplay of the page displayed previously, and a paging process for skipping a plurality of pages can be realized.

The paging state management unit 210 instructs the paging position calculation unit 220 to execute the processing when receiving the paging start/end instruction. Further, the paging state management unit 210 notifies the content management unit 230 of the designated information of the next image.

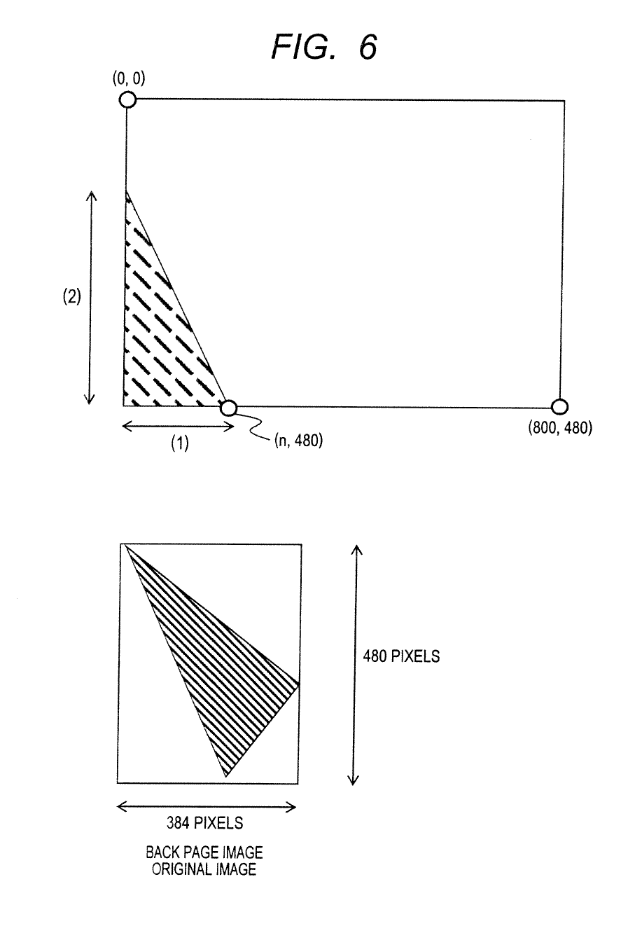

The paging position calculation unit 220 calculates coordinates for generating display boundary screen information that will be described later. The paging position calculation unit 220 notifies the display boundary processing unit 50 of the calculated coordinates. Further, the paging position calculation unit 220 calculates an area to be displayed in the back page image, and coordinates at which the region is displayed in the paging image. The paging position calculation unit 220 notifies the back page image processing unit 60 of the calculated area to be displayed in the back page image, and the calculated coordinates at which the area is displayed in the paging image. The detail of the calculating process by the paging position calculation unit 220 will be described later with reference to FIGS. 6 to 10.

The paging position calculation unit 220 calculates an enlargement factor of the present image so as to be suited to a screen size of the image processing apparatus 1, and notifies a present-image scaling unit 320 of the enlargement factor. Likewise, the paging position calculation unit 220 calculates an enlargement factor of the next image so as to be suited to the screen size of the image processing apparatus 1, and notifies a next-image scaling unit 420 of the enlargement factor. As a result, there is no limit of the size of the image data stored in the storage unit 10, and a large amount of contents can be displayed on a display unit (not shown) of the image processing apparatus 1.

The content management unit 230 designates the image to be read as the present image with respect to a present-image acquisition unit 310. The content management unit 230 designates the image to be read as the next image with respect to a next-image acquisition unit 410. Further, the content management unit 230 designates the image to be read as the back image with respect to a back-image acquisition unit 610.

The present-image processing unit 30 includes the present-image acquisition unit 310 and the present-image scaling unit 320. The present-image processing unit 30 receives the designation of the present image, and the enlargement factor of the present image from the display control unit 20. The present-image acquisition unit 310 reads the designated present image from the storage unit 10, and supplies the read image to the present-image scaling unit 320. The present-image scaling unit 320 scales the present image at the received enlargement factor. The present-image scaling unit 320 supplies the scaled present image to the mixer unit 70.

The next-image processing unit 40 includes the next-image acquisition unit 410 and the next-image scaling unit 420. The next-image processing unit 40 receives the designation of the next image, and the enlargement factor of the next image from the display control unit 20. The next-image acquisition unit 410 reads the designated next image from the storage unit 10, and supplies the read image to the next-image scaling unit 420. The next-image scaling unit 420 scales the next image at the received enlargement factor. The next-image scaling unit 420 supplies the scaled next image to the mixer unit 70.

The display boundary processing unit 50 creates information (hereinafter referred to as “display boundary screen information”) related to a display boundary that separates between the display area of the present image and the display area of the next image. The display boundary processing unit 50 receives the display coordinates of the next image from the display control unit 20. The display boundary processing unit 50 receives the display coordinates of the next image from the display control unit 20. The display boundary processing unit 50 creates the display boundary screen information from the received display coordinates. The display boundary screen information has the same pixel size (800×480) as that of the display screen in the image processing apparatus 1, and information of 1 bit is set for each pixel. For example, “1” is set for pixels in the display area of the present image, and, for example, “0” is set for pixels in the display area of the next image.

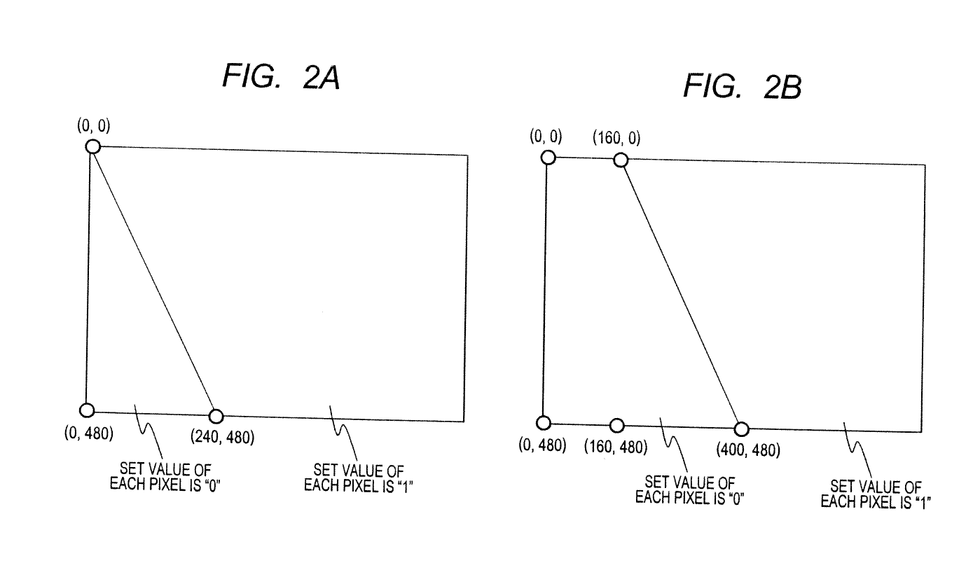

Referring to FIGS. 2A and 2B, the display boundary screen information will be described. FIG. 2A illustrates the display boundary screen information when vertexes (0, 0), (0, 480), and (240, 480) of a triangle are allocated as the display coordinates of the next image. FIG. 2B illustrates the display boundary screen information when vertexes (160, 0), (160, 480), (400, 480) of a triangle, and the vertexes (0, 0), (160, 0), (0, 480), (160, 480) of a square are allocated as the display coordinates of the next image. Thus, the display coordinates of the next image are allocated as the coordinates of the triangle and square from the storage unit 10, and the display boundary screen information is created on the basis of the coordinates as illustrated in FIG. 2.

Thus, because only information of a bit string of “0” or “1” is set for each pixel of the display boundary screen information, the display boundary processing unit 50 can generate the display boundary screen information at a high speed. Further, the data size of the display boundary screen information can be reduced.

The description returns to FIG. 1. The back page image processing unit 60 includes the back-image acquisition unit 610 and an image scaling unit 620. The back page image processing unit 60 receives, from the display control unit 20, the designation of the back page image, the coordinate information of the area to be displayed in the back page image, and the display coordinates to be displayed in the paging image.

The back-image acquisition unit 610 reads the designated back page image from the storage unit 10. The image scaling unit 620 adjusts the scale of the back page image on the basis of the coordinates of the area to be displayed in the back page image input from the display control unit 20, and the display coordinates in the paging image. The image scaling unit 620 notifies the mixer unit 70 of the back page image adjusted in scale, and the display coordinates at which the back page image is displayed in the paging image.

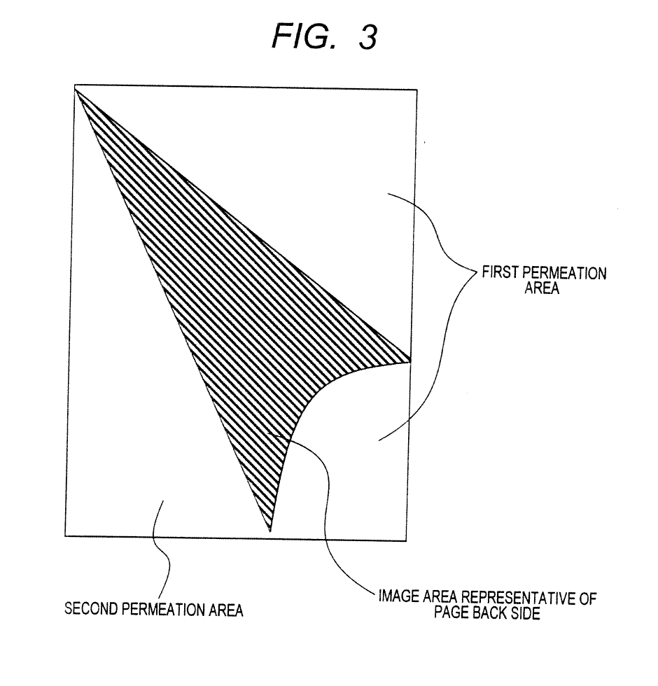

FIG. 3 is a diagram illustrating an example of the back page image. The back page image includes a first permeation area that is subjected to permeabilization for displaying the present image, a second permeation area that is subjected to permeabilization for displaying the next image, and an image area representative of a page back side. The permeabilization conducted on the first permeation area and the second permeation area may be, for example, a blending.

A boundary between the image area representative of the page back side, and the first or second permeation area may be curved as illustrated in FIG. 3. Further, one side (a side forming the boundary between the second permeation area and the image area representative of the page back side) of the image area representative of the page back side is set at the same angle so as to be superimposed on an oblique line indicative of the display boundary within the display boundary screen information. With this configuration, the image area indicative of the page back side can be arbitrarily shaped. As a result, a situation in which a page end is floating by paging can be expressed.

The effect of expressing a shadow appearing during paging is added to the image area indicative of the page back side. In more detail, a virtual light source is arranged, and coordinates at which the shadow appears during paging are calculated. The pixel in which the effect of a value is added to black is arranged with respect to the coordinates. In general, the image effect expressing the shadow is larger in visual influence than the image effect expressing three-dimensional strain. For that reason, with only allocation of the image effect expressing the shadow, an impression that a page is sufficiently turned can be given the user.

The description returns to FIG. 1. The mixer unit 70 receives the present image from the present-image processing unit 30, the next image from the next-image processing unit 40, and the display boundary screen information from the display boundary processing unit 50. Further, the mixer unit 70 receives the back page image and the display position coordinates of the back page image from the back page image processing unit 60. The mixer unit 70 creates a combined image in which the present image and the next image are combined together on the basis of the display boundary screen information. The mixer unit 70 superimposes the combined image on the back page image to generate a paging image. In superimposing the images, the mixer unit 70 arranges the back page image in conformity to the display position coordinates of the back page, which are supplied from the back page image processing unit 60. The mixer unit 70 appropriately supplies the generated paging image to the display unit (not shown) of the image processing apparatus 1.

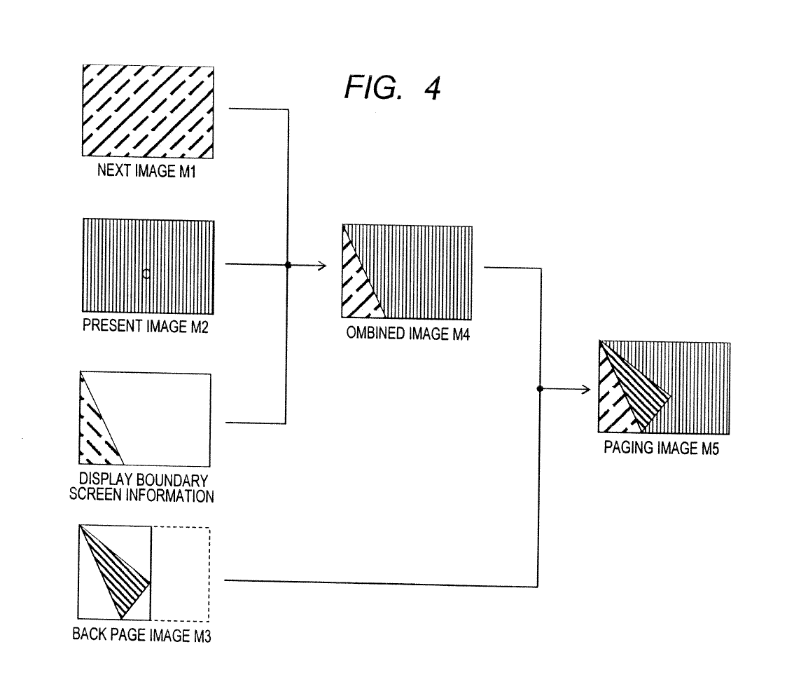

Subsequently, referring to FIG. 4, a description will be given of a process of generating the paging image with an entire area of the back page image to be displayed. The next image M1 is scaled by the next-image processing unit 40 in conformity to a desired display size in advance. Likewise, the present image M2 is scaled by the present-image processing unit 30 in conformity to a desired display size in advance. The mixer unit 70 generates the combined image M4 in which the next image M1 and the present image M2 are combined together according to area setting indicated by the display boundary screen information. The next image M1 is displayed at a triangular place including a left and lower side of the screen of the combined image M4. The present image M2 is displayed at a place other than the triangle including the left and lower side of the screen of the combined image M4. The combined image M4 is used only within the mixer unit 70.

The back page image M3 is scaled by the back page image processing unit 60 in advance so that the display boundary of the combined image M4 matches one side of the area indicative of the back page. Further, in the mixer unit 70, the display position coordinates of the back page image M3 is supplied to the back page image processing unit 60. The mixer unit 70 superimposes the back page image M3 on the combined image M4 at the designated display position to generate the paging image M5.

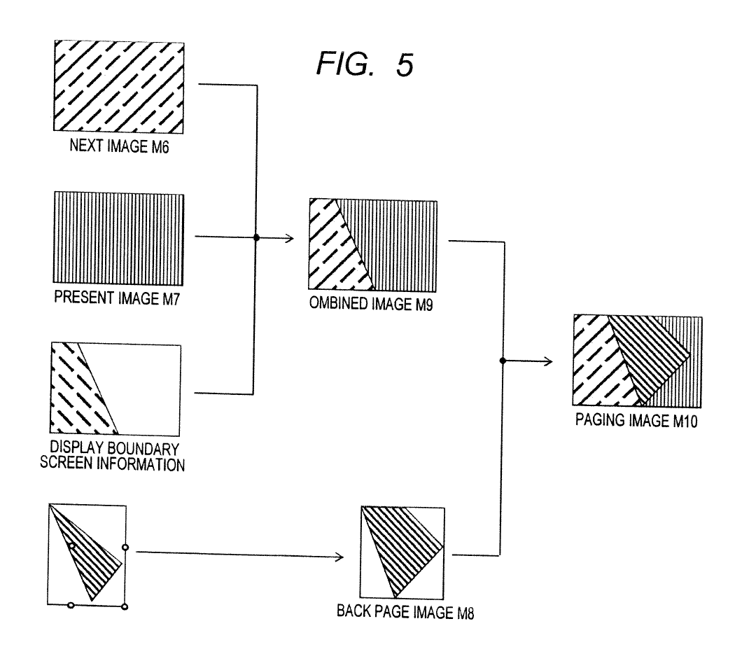

Subsequently, referring to FIG. 5, a description will be given of a process of generating the paging image with a partial area of the back page image to be displayed. The generation of a combined image M9 is identical with the process of generating the combined image M4 in FIG. 4. The back page image processing unit 60 enlarges the back page image on the basis of the area to be displayed which is input from the display control unit 20, and the display coordinates on the paging image. In an example of FIG. 5, an image M8 is generated in which a square area surrounded by white circles is extracted and enlarged on the basis of the display coordinates on the paging image. Thus, the back page image processing unit 60 enlarges the area to be displayed from the back page image, and generates the image M8 that is the back page image for display. In more detail, the back page image processing unit 60 adjusts the partial or entire scale of the back page image to generate the back page image for display. The mixer unit 70 superimposes the back page image M8 on the combined image M9 at the display position of the designated paging image to generate a paging image M10.

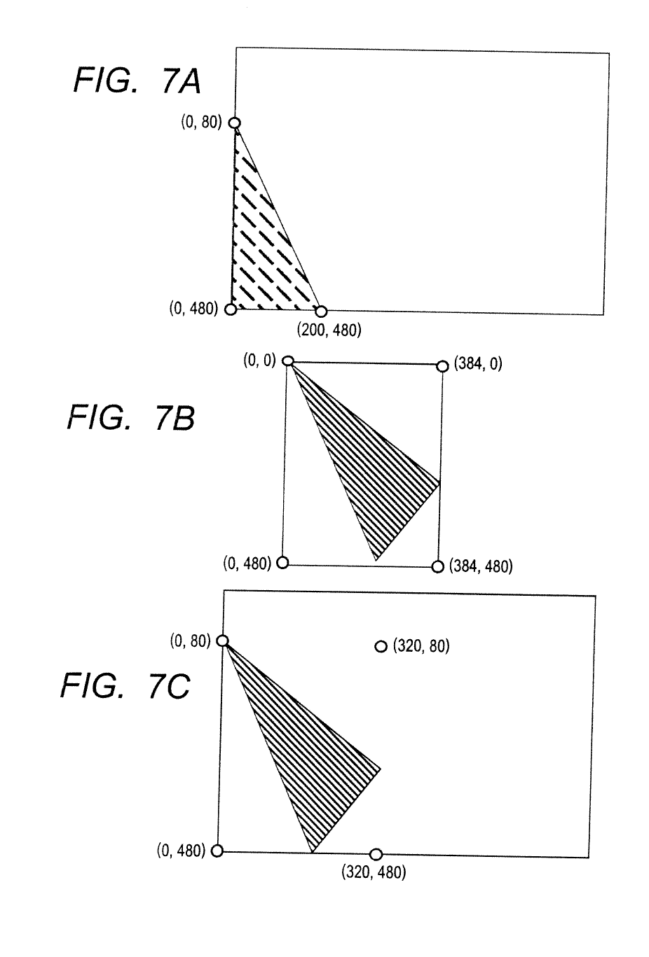

Subsequently, referring to FIGS. 6 to 10, a calculating process by the paging position calculation unit 220 will be described. The calculating method by the paging position calculation unit 220 changes according to the transition of the paging position. First, a coordinate system used for description of FIGS. 7 to 10 will be described with reference to FIG. 6. In the description, it is assumed that the size of the original image of the back page image is 384 in the number of horizontal pixels and 480 in the number of vertical pixels. Also, it is assumed that the horizontal/vertical ratio of the triangle (area in which the next image is displayed) that is scaled within the display boundary screen information is 1:2. The number of pixels in the display unit of the image processing apparatus 1 is 800 pixels in the horizontal direction and 480 pixels in the vertical direction as described above. It is assumed that the coordinate system is (0, 0) at the left and upper coordinates and (800, 480) at the right and lower coordinates. It is assumed that an X-coordinate at an end of Y-coordinate=480, which is one end of the display boundary between the present image and the next image, is n. In the description of FIGS. 7 to 10, for simplification of description, it is assumed that the image area indicative of the back page in the back page image is triangular.

FIGS. 7A to 7C are diagrams illustrating a relationship among the display boundary screen information, the area to be displayed in the back page image, and the display position of the back page image within the paging image in the case of 0<n≦240. FIGS. 7A to 7C illustrate coordinate values in the case of n=200.

The display area of the next image in the display boundary screen information falls within a range of the following vertex coordinates of the triangle (FIG. 7A). That is, the vertex coordinates are (0, 480−2×n), (n, 480), and (0, 480).

The area to be displayed within the original image of the back page image is represented by the following coordinate values (FIG. 7B). The coordinate values are left=0, right=384, top=0, and bottom=480. In this example, “left” and “right” indicate values of x-coordinates. “top” and “bottom” indicate values of y-coordinates. That is, the area to be displayed in the original image of the back page image is surrounded by coordinates of (0, 0), (0, 480), (384, 0), and (384, 480). The same is applied to the following description.

The coordinates of the area in which the back page image is displayed in the paging image are represented as follows (FIG. 7C). That is, the coordinates of the area are left=0, right=(8/5)×n, top=480−2×n, and bottom=480.

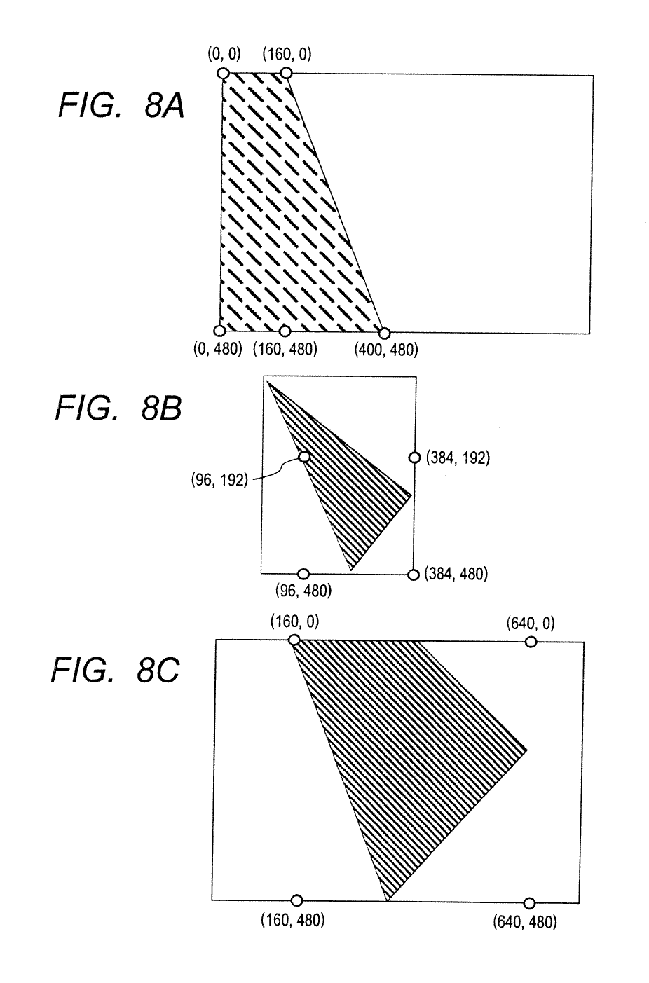

Subsequently, a relationship among the display boundary screen information, the area to be displayed in the back page image, and the display position of the back page image within the paging image in the case of 240<n≦500 will be described with reference to FIGS. 8A to 8C. FIGS. 8A to 8C illustrate the coordinate values in the case of n=400.

The display area of the next image in the display boundary screen information falls within the ranges of a triangle and a square defined by the following coordinates (FIG. 8A). That is, he coordinates of the triangle are (n−240, 0), (n, 480), and (n−240, 480), and the vertex coordinates of the square are left=0, right=n−240, top=0, and bottom=480.

The area to be displayed within the original image of the back page image is represented by the following coordinate values (FIG. 8B). That is, the coordinate values are left=240×(n−240)/n, right=384, top=480×(n−240)/n, and bottom=480.

The coordinates of the area in which the back page image is displayed in the paging image are represented by the following coordinate values (FIG. 8C). That is, the coordinate values are left=n−240, right=(8/5)×n, top=0, and bottom=480.

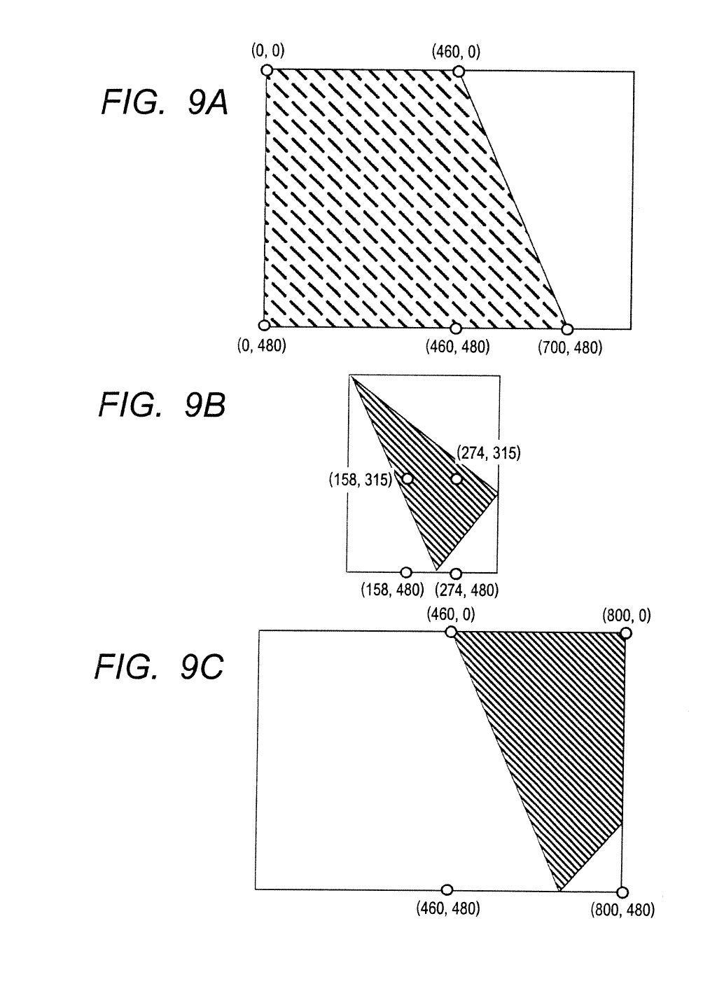

Subsequently, a relationship among the display boundary screen information, the area to be displayed in the back page image, and the display position of the back page image within the paging image in the case of 500<n≦800 will be described with reference to FIGS. 9A to 9C. FIGS. 9A to 9C illustrate the coordinate values in the case of n=700.

The display area of the next image in the display boundary screen information falls within the ranges of a triangle and a square defined by the following coordinates (FIG. 9A). The coordinates of the triangle are (n−240, 0), (n, 480), and (n−240, 480), and the vertex coordinates of the square are left=0, right=n−240, top=0, and bottom=480.

The area to be displayed within the original image of the back page image is represented by the following coordinate values (FIG. 9B). That is, the coordinate values are left=240×(n−240)/n, right=384×(1−(n−500)/n), top=480×(n−240)/n, and bottom=480.

The coordinates of the area in which the back page image is displayed in the paging image are represented by the following coordinate values (FIG. 9C). That is, the coordinate values are left=n−240, right=800, top=0, and bottom=480.

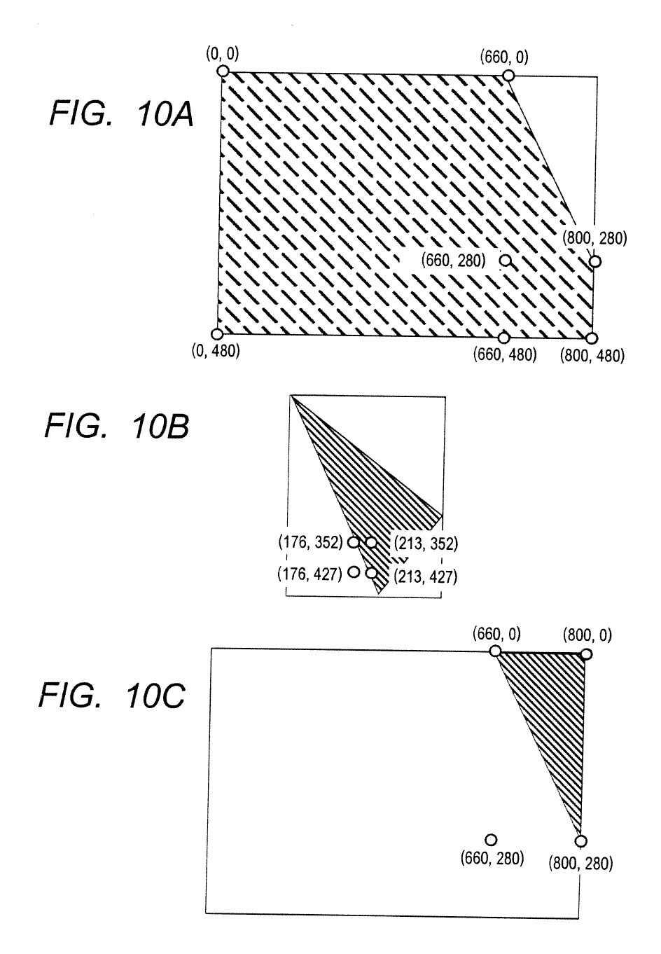

Subsequently, a relationship among the display boundary screen information, the area to be displayed in the back page image, and the display position of the back page image within the paging image in the case of 800<n≦1040 will be described with reference to FIGS. 10A to 10C. FIGS. 10A to 10C illustrate the coordinate values in the case of n=900.

The display area of the next image in the display boundary screen information falls within the ranges of a triangle and two squares (first square and second square) defined by the following coordinates (FIG. 10A). The coordinates of the triangle are (n−240, 0), (800, (1040−n)×2), and (n−240, (1040−n)×2), the vertex coordinates of the first square are left=0, right=n−240, top=0, and bottom=480, and the vertex coordinates of the second square are left=n−240, right=800, top=(1040−n)×2, and bottom=480.

The area to be displayed within the original image of the back page image is represented by the following coordinate values (FIG. 10B). That is, the coordinate values are left=240×(n−240)/n, right=384×(1−(n−500)/n), top=480×(n−240)/n, and bottom=480×(1−(n−800)/n).

The coordinates of the area in which the back page image is displayed in the paging image are represented by the following coordinate values (FIG. 10C). That is, the coordinate values are left=n−240, right=800, top=0, and bottom=(1040−n)×2.

As described above, the paging position calculation unit 220 divides the paging transition into four states, and calculates the display boundary screen information, the area to be displayed in the back page image, and the display position of the back page image within the paging image in each state. According to the calculated values, the image scaling unit 620 scales the display area of the back page.

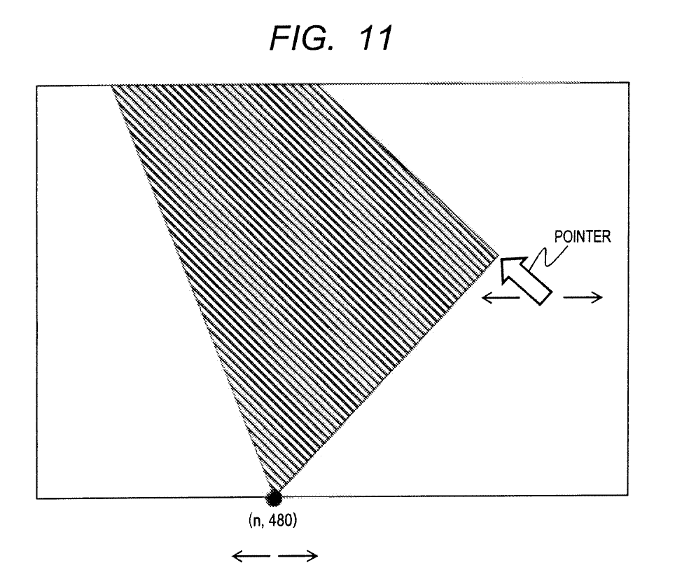

The above value of n (a value of the X-coordinate at an end point of Y-coordinate=480 which is one end of the display boundary between the present image and the next image) is increased at a fixed rate, thereby obtaining the effect of paging at a fixed speed. As a result, the visual effect of smoothly paging can be expressed. However, the paging speed is not limited to the fixed speed, but paging may be conducted according to the coordinate designation by the user. An example will be illustrated in FIG. 11.

FIG. 11 is a diagram illustrating a display screen of the image processing apparatus 1. The user moves a pointer on the display screen in a horizontal direction with the use of a remote controller of the image processing apparatus 1. With this operation, the user increases or decreases the value of n (the value of the X-coordinate at an end point of Y-coordinate=480 which is one end of the display boundary between the present image and the next image). When the image processing apparatus 1 has a touch panel, the user may touch the touch panel, and move the page end in the horizontal direction. The user can thus operate the paging position whereby the user can continuously display the present image and the next image at a display rate desired by the user.

In the above-mentioned examples of FIGS. 7A to 10C, specific numerical values of the screen size of the image processing apparatus 1 are assumed. However, the above calculating system can be generalized as follows. In the following description, it is assumed that the screen size of the image processing apparatus is H in the number of horizontal pixels and V in the number of vertical pixels. It is assumed that the size of the original image of the back page image is x in the number of horizontal pixels and y in the number of vertical pixels. It is assumed that the coordinate system is (0, 0) at the left and upper coordinates, and (H, V) at the right and lower coordinates. It is assumed that the X-coordinate at an end point of Y-coordinate=V which is one end of the display boundary between the present image and the next image is n. It is assumed that the horizontal/vertical ratio of the range of the right triangle, which is the display area of the next image, in the display boundary screen information is a:b. Further, the constants are defined by c=(b×x)/(a×y) and d=a/b.

A description will be given of the display boundary screen information, the area to be displayed in the back page image, and the display position of the back page image within the paging image in the case of 0<n≦(V×d).

The display area of the next image in the display boundary screen information falls within a range of the following vertex coordinates of a triangle. That is, the vertex coordinates are (0, V−(n/d)), (n, V), and (0, V).

The area to be displayed within the original image of the back page image is represented by the following coordinate values. That is, the coordinate values are left=0, right=x, top=0, and bottom=y.

The coordinates of the area in which the back page image is displayed in the paging image are represented as follows. That is, the coordinate values are left=0, right=c×n, top=V−(n/d), and bottom=V.

Subsequently, a description will be given of the display boundary screen information, the area to be displayed in the back page image, and the display position of the back page image within the paging image in the case of (V×d)<n≦(H/c).

The display area of the next image in the display boundary screen information falls within the ranges of a triangle and a square defined by the following coordinates. That is, the coordinates of the triangle are (n−d×V, 0), (n, V), and (n−d×V, V), and the vertex coordinates of the square are left=0, right=n−(d×V), top=0, and bottom=V.

The area to be displayed within the original image of the back page image is represented by the following coordinate values. That is, the coordinate values are left=(d×y×(n−V×d))/n, right=x, top=(y×(n−V×d))/n, and bottom=y.

The coordinates of the area in which the back page image is displayed in the paging image are represented as follows. That is, the coordinate values are left=n−d×V, right=c×n, top=0, and bottom=V.

Subsequently, a description will be given of the display boundary screen information, the area to be displayed in the back page image, and the display position of the back page image within the paging image in the case of (H/c)<n≦H.

The display area of the next image in the display boundary screen information falls within the ranges of a triangle and a square defined by the following coordinates. That is, the coordinates of the triangle are (n−d×V, 0), (n, V), and (n−d×V, V), and the vertex coordinates of the square are left=0, right=n−(d×V), top=0, and bottom=V.

The area to be displayed within the original image of the back page image is represented by the following coordinate values. That is, the coordinate values are left=(d×y×(n−V×d))/n, right=(x×H)/(c×n), top=(y×(n−V×d))/n, and bottom=y.

The coordinates of the area in which the back page image is displayed in the paging image are represented as follows. That is, the coordinate values are left=n−d×V, right=H, top+0, and bottom=V.

Subsequently, a description will be given of the display boundary screen information, the area to be displayed in the back page image, and the display position of the back page image within the paging image in the case of H<n≦(H+V×d).

The display area of the next image in the display boundary screen information falls within the ranges of a triangle and two squares (first square and second square) defined by the following coordinates. The coordinates of the triangle are (n−d×V, 0), (H, V−((n−H)/d)), and (n−d×V, V−((n−H)/d)), the vertex coordinates of the first square are left=0, right=n−d×V, top=0, and bottom=V, and the vertex coordinates of the second square are left=n−d×V, right=H, top=V−((n−H)/d)), and bottom=V.

The area to be displayed within the original image of the back page image is represented by the following coordinate values. That is, the coordinate values are left=(d×y×(n−V×d))/n, right=(x×H)/(c×n), top=(y×(n−V×d))/n, and bottom=(y×H)/n.

The coordinates of the area in which the back page image is displayed in the paging image are represented as follows. That is, the coordinate values are left=n−d×V, right=H, top=0, and bottom=V−((n−H)/d).

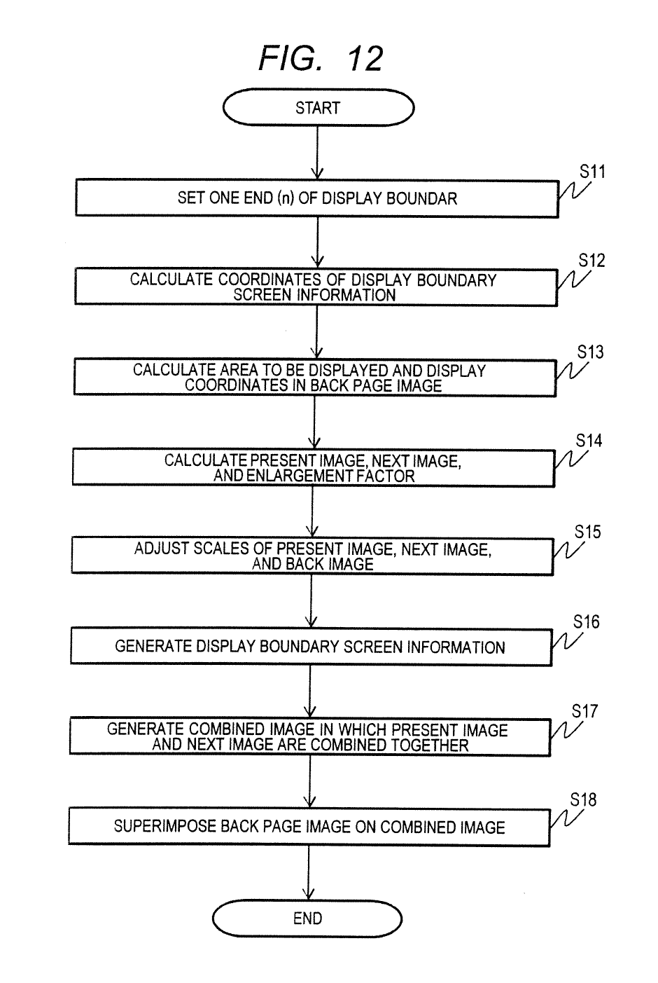

Subsequently, the processing of the image processing apparatus 1 according to this embodiment will be described with reference to FIG. 12. The display control unit 20 sets the coordinates (n in FIG. 6) of one end of the display boundary through an arbitrary method (S11). The display control unit 20 calculates the coordinates for generating the display boundary screen information according to the set coordinates of one end of the display boundary (S12). Further, the display control unit 20 calculates the area to be displayed in the back page image, and the position coordinates at which the area is displayed in the paging image on the basis of the coordinates of one end of the display image (S13). The display control unit 20 calculates the enlargement factors of the present image and the next image (S14).

The present-image processing unit 30 adjusts the scale of the present image acquired from the storage unit 10 in conformity to the calculated enlargement factor (S15). Likewise, the next-image processing unit 40 adjusts the scale of the next image acquired from the storage unit 10 in conformity to the calculated enlargement factor (S15). The back page image processing unit 60 adjusts the scale of the back page image acquired from the storage unit 10 in conformity to the calculated enlargement factor (S15).

The display boundary processing unit 50 generates the display boundary screen information on the basis of the coordinate information calculated by the display control unit 20 (S16).

The mixer unit 70 generates the combined image in which the present image and the next image which have been adjusted in scale are combined together on the basis of the display boundary screen information (S17). The mixer unit 70 superimposes the combined image on the back page image at the position calculated by the display control unit 20 to generate the paging image (S18).

The present invention is not limited to the above processing order, but the processing of S12 to S14 is in random order, and may be conducted at the same time. Also, the processing of S17 and S18 can be executed at the same time by determining the output value every one pixel, and the output result of S17 may not be output onto the screen.

Subsequently, the advantages of the image processing apparatus according to this embodiment will be described. As described above, the image processing apparatus 1 conducts only the process of calculating the coordinates, the scale adjustment of the image, and the superimposing of the image when generating the paging image. The process of calculating the coordinates is a simple process for obtaining the coordinates of the triangle or square. In other words, the image processing apparatus 1 can generate the paging image without conducting processing high in processing load such as processing of the image. As a result, even if the apparatus is low in processing performance, the paging effect can be realized. Further, because the processing high in the processing load is not conducted, a response to the instruction from the user is improved.

Furthermore, even if the image size dealt with by the image processing apparatus 1 is changed, only the process of calculating the coordinates, the scale adjustment of the image, and the superimposing of the image are conducted, and there is no need to conduct a process of increasing the processing load due to an increase in the image size. For that reason, the image processing apparatus 1 can easily realize the paging effect even if a moving image generally high in processing load is dealt with.

Further, when the effects of page curl and shadow are applied to the back page image, the visual effect of paging can be improved while keeping an inexpensive configuration.

The present invention is not limited to the above embodiment, but can be appropriately changed without departing from the subject matter of the present invention. For example, in the above description, it is assumed that the page is turned from left to right. Alternatively, a direction of paging may be arbitrarily changed.

When all of the images stored within the storage unit 10 have the same size as that of the display screen of the image processing apparatus 1, the present-image processing unit 30 and the next-image processing unit 40 can be omitted. In this case, the display control unit 20 notifies the mixer unit 70 of the present image and the next image, and the mixer unit 70 reads the present image and the next image from the storage unit 10.

In the above description, the display boundary screen information is set, and the display areas of the present image and the next image are set. However, the present invention is not limited to this configuration, but the combined image of the present image and the next image can be generated on the basis of the coordinate information indicative of the display boundary and the image size of the page image through an arbitrary method.

Further, in the above description, it is assumed that the image processing apparatus 1 is a TV receiver. However, the present invention is not always limited to this configuration, but may be applied to a compact display device such as a set-top box or a DVD (digital versatile disc) media, or a cellular phone unit.

The processing of the respective processing units in the display control unit 20 may be executed as a program that operates within an arbitrary computer. The program can be stored in various types of non-transitory computer readable mediums, and can be supplied to the computer. The non-transitory computer readable medium includes various types of tangible storage mediums. The non-transitory computer readable mediums are exemplified by magnetic recording mediums (for example, a flexible disc, a magnetic tape, a hard disc drive), magneto-optical recording mediums (for example, a magneto-optical disk), a CD-ROM (Read Only Memory), a CD-R, a CD-R/W, semiconductor memories (for example, a mask ROM, a PROM (programmable ROM), an EPROM (erasable PROM), a flash ROM, and a RAM (random access memory)). Also, the program may be supplied to the computer by various types of transitory computer readable mediums). The transitory computer readable mediums are exemplified by an electric signal, a light signal, and an electromagnetic wave. The transitory computer readable mediums can supply the program to the computer through a wired communication channel such as an electric wire or an optical fiber or a wireless communication channel.

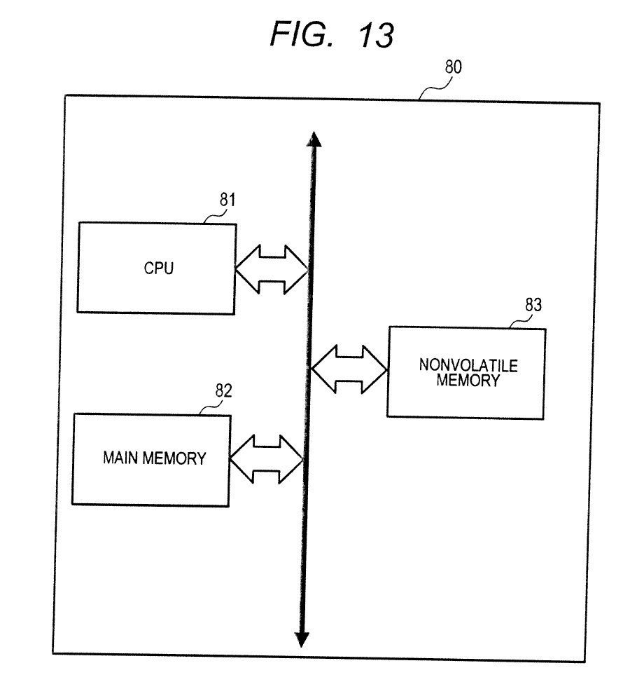

When the processing of the respective processing units in the display control unit 20 is realized by as a program that operates within an arbitrary computer, a configuration of the computer in which the program operates is illustrated in FIG. 13. A computer 80 has, for example, a CPU 81, a main memory 82, and a nonvolatile memory 83 connected to each other through a bus.

What is claimed is:

1. An image processing apparatus for generating a paging image when a display image for a plurality of pages is displayed for each page, which calculates coordinates of a display boundary between a present image that is a present display image and a next image to be displayed after paging, and provides a back page image used to represent a page back associated with the display boundary, the image processing apparatus comprising:
a display control unit that calculates an area to be displayed used for generation of the paging image;
a back image processing unit that adjusts a scale of the area to be displayed for the back page image on the basis of a position of the display boundary to generate a display back page image; and
a mixer unit that generates a combined image in which the present image and the next image are combined together on the basis of the display boundary, and superimposes the display back page image on the combined image on the basis of the display boundary to generate the paging image.

2. The image processing apparatus according to claim 1,
wherein the back page image includes a first permeation area in which the present image is displayed, a second permeation area in which the next image is displayed, and a non-permeation area representative of the page back.

3. The image processing apparatus according to claim 2,
wherein a boundary between the non-permeation area and the second permeation area of the back page image coincides with the display boundary.

4. The image processing apparatus according to claim 1,
wherein the display control unit switches a method of calculating the area to be displayed and position coordinates at which the display back page image is displayed in the paging image to another method according to the coordinates of one end of the display boundary.

5. The image processing apparatus according to claim 1, further comprising: a display boundary processing unit that generates display boundary screen information indicative of a display area for displaying the present image and a display area for displaying the next image, on the basis of the coordinates of the display boundary,
wherein the mixer unit generates the combined image by using the present image and the next image on the basis of the display boundary screen information.

6. The image processing apparatus according to claim 5,
wherein the display control unit switches a method of calculating the coordinates used for generation of the display boundary screen information to another method according to the coordinates of one end of the display boundary.

7. The image processing apparatus according to claim 1, further comprising: a storage unit that stores the present image, the next image, and the back page image;
a present-image processing unit that supplies the present image to the mixer unit after reading the present image from the storage unit, and adjusting the scale of the present image; and
a next-image processing unit that supplies the present image to the mixer unit after reading the next image from the storage unit, and adjusting the scale of the next image,
wherein the back page image processing unit reads the back page image from the storage unit.

8. The image processing apparatus according to claim 1,
wherein the display control unit sets the next image according to an input instruction from a user.

9. The image processing apparatus according to claim 1,
wherein the display control unit sets the coordinates of one end of the display boundary according to an input instruction from a user.

10. The image processing apparatus according to claim 2,
wherein a boundary between the non-permeation area and the first or second permeation area included in the back page image includes a boundary.

11. The image processing apparatus according to claim 5,
wherein the display boundary screen information has the same number of pixels as that of the paging image, and any value of a bit indicative of the display area of the present image and a bit indicative of the display area of the next image is set for each of the pixels.

12. The image processing apparatus according to claim 2,
wherein when it is assumed that the number of horizontal pixels is H and the number of vertical pixels is V in the paging image, the number of horizontal pixels is x and the number of vertical pixels is y in the back page image, an X-coordinate at an end point having a Y-coordinate of V which is one end of the display boundary is n, a horizontal/vertical ratio of a range of a right triangle which is a display area of the next image in the display boundary screen information is a:b, a constant c is equal to (b×x)/(a×y), and a constant d is equal to a/b, the display control unit calculates the coordinates of the display boundary screen information, and the display position and the range to be displayed of the back page image according to each of four conditions stated below:
in the case of 0<n≦(V×d):
the display area of the next image in the display boundary screen information is an area of a triangle defined by (0, V−(n/d)), (n, V), and (0, V), the area to be displayed falls within an area surrounded by a square defined by coordinates of (left, top), (left, bottom), (right, top), and (right, bottom) when left=0, right=x, top=0, and bottom=y are assumed, and the position coordinates at which the display back page image is displayed in the paging image are left=0, right=c×n, top=V−(n/d), and bottom=V, in the case of (V×d)<n≦(H/c):
the display area of the next image in the display boundary screen information is an area of a triangle defined by (0, V−(n/d)), (n, V), and (0, V), and falls within a range surrounded by a square defined by coordinates of left=0, right=n−(d×V), top=0, and bottom=V,
the area to be displayed is left=(d×y×(n−V×d))/n, right=x, top=(y×(n−V×d))/n, and bottom=y, and
the position coordinates at which the display back page image is displayed in the paging image are left=n−d×V, right=c×n, top=0, and bottom=V,
in the case of (H/c)<n≦H:
the display area of the next image in the display boundary screen information is an area of a triangle defined by (n−d×V, 0), (n, V), and (n−d×V, V), and falls within a range surrounded by a square defined by coordinates of left=0, right=n−d×V, top=0, and bottom=V,
the area to be displayed is left=(d×y×(n−V×d))/n, right=(x×H)/(c×n), top=(y×(n−V×d))/n, and bottom=y, and
the position coordinates at which the display back page image is displayed in the paging image are left=n−d×V, right=H, top=0, and bottom=V, and
in the case of H<n≦(H+V×d):
the display area of the next image in the display boundary screen information is an area of a triangle defined by (n−d×V, 0), (n, V), and (n−d×V, V), and falls within a range surrounded by two squares defined by coordinates of (n−d×V, 0), (H, V−((n−H)/d)), (n−d×V, V−((n−H)/d)), left=0, right=n−d×V, top=0, bottom=V, left=n−d×V, right=H, top=V−((n−H)/d), and bottom=V,
the area to be displayed is left=(d×y×(n−V×d))/n, right=(x×H)/(c×n), top (y×(n−V×d))/n, and bottom=(y×H)/n, and
the position coordinates at which the display back page image is displayed in the paging image are left=n−d×V, right=H, top=0, and bottom V−((n−H)/d).

13. The image processing apparatus according to claim 1,
wherein at least one of the present image and the next image is a moving image.

14. An image processing method for generating a paging image when a display image for a plurality of pages is displayed for each page, which calculates coordinates of a display boundary between a present image that is a present display image and a next image to be displayed after paging, and provides a back page image used to represent a page back associated with the display boundary, the image processing method comprising the steps of:
calculating an area to be displayed used for generation of the paging image;
generating a display back page image that is an image having the area to be displayed for the back page image adjusted in scale on the basis of the display boundary; and
superimposing the display back page image on a combined image in which the present image and the next image are combined together on the basis of the display boundary, on the basis of the display boundary, to generate the paging image.

15. A computer readable recording medium storing an image processing program that causes a computer to execute a process for calculating coordinates of a page switching image when a display image for a plurality of pages is displayed for each page, the process comprising:
calculating a display boundary between a present image that is a present display image and a next image to be displayed after paging; and
calculating an area to be displayed which is displayed during the paging image from a back page image representative of a page back associated with the display boundary on the basis of the display boundary.
